(19) United States
(12) Patent Application Publication
(10) Pub. No.: US 2015/0242640 A1
(43) Pub. Date: Aug. 27, 2015

(54) ENCRYPTION KEY SELECTION

(71) Applicant: Western Digital Technologies, Inc., Irvine, CA (US)

(72) Inventors: DMITRY S. OBUKHOV, SAN JOSE, CA (US); ZHENCHUAN CHAI, SAN JOSE, CA (US)

(73) Assignee: Western Digital Technologies, Inc., Irvine, CA (US)

(21) Appl. No.: 14/250,650

(22) Filed: Apr. 11, 2014

Related U.S. Application Data
(60) Provisional application No. 61/943,726, filed on Feb. 24, 2014.

(51) Int. Cl. G06F 21/60

(52) U.S. Cl. CPC G06F 21/602

(57) ABSTRACT

Systems and methods are disclosed for encrypting and/or decrypting data in a data storage environment. A data storage device controller is configured to extract parameters from host memory access commands and use key selection circuitry to select an encryption model based on the parameters. Key selection is determined by the selected encryption model.

### RELATED APPLICATION

This application claims the benefit of priority under 35 U.S.C. §119(e) of U.S. Provisional Application No. 61/943,726, filed on Feb. 24, 2014, and entitled “Encryption Key Selection,” the disclosure of which is hereby incorporated by reference in its entirety.

### BACKGROUND

1. Field

This disclosure relates to data encryption systems. More particularly, the disclosure relates to systems and methods for selecting media encryption keys.

2. Description of Related Art

In data encryption systems, encryption keys are used to determine the functional output of cryptographic algorithms for the purpose of encrypting and/or decrypting data. Various models exist for selecting encryption keys in data storage environments.

### BRIEF DESCRIPTION OF THE DRAWINGS

Various embodiments are depicted in the accompanying drawings for illustrative purposes, and should in no way be interpreted as limiting the scope of this disclosure. In addition, various features of different disclosed embodiments can be combined to form additional embodiments, which are part of this disclosure.

FIG. 1 is a block diagram of a data storage system according to an embodiment.

FIG. 2A is a block diagram illustrating a storage encryption system including encryption key selection circuitry according to an embodiment.

FIGS. 2B-2E are block diagrams illustrating modules in an encryption key selection system.

FIG. 3 is a block diagram illustrating a process flow for a key selection process according to an embodiment.

FIG. 4 is a flow diagram illustrating a process for selecting encryption keys according to an embodiment.

### DETAILED DESCRIPTION

While certain embodiments are described, these embodiments are presented by way of example only, and are not intended to limit the scope of protection. Indeed, the novel methods and systems described herein may be embodied in a variety of other forms. Furthermore, various omissions, substitutions and changes in the form of the methods and systems described herein may be made without departing from the scope of protection.

As used in this application, “non-volatile solid-state memory,” “non-volatile memory,” “NVM,” or variations thereof may refer to solid-state memory such as NAND flash. However, the systems and methods of this disclosure may also be useful in more conventional hard drives and hybrid drives including both solid-state and hard drive components. Solid-state memory may comprise a wide variety of technologies, such as flash integrated circuits, Phase Change Memory (PC-RAM or PRAM), Programmable Metallization Cell RAM (PMC-RAM or PMCm), Ovonic Unified Memory (OUM), Resistance RAM (RRAM), NAND memory, NOR memory, EEPROM, Ferroelectric Memory (FeRAM), MRAM, or other discrete NVM (non-volatile solid-state memory) chips. The non-volatile solid-state memory arrays or storage devices may be physically divided into planes, blocks, pages, and sectors, as is known in the art. Other forms of storage (e.g., battery backed-up volatile DRAM or SRAM devices, magnetic disk drives, etc.) may additionally or alternatively be used.

### Overview

In data storage environments, protection of electronic data from unauthorized accesses or use by third parties may be necessary or desirable. For example, e-commerce, remote access, wireless networking, and/or other environments often utilize various data encryption/decryption protocols, or techniques, for securing data in order to preserve data confidentiality, integrity, and/or authenticity. Data encryption involves the conversion of information from a readable state to an apparently un-readable state through the use of cryptographic algorithms and/or keys (e.g., “media encryption keys” (MEKs)).

Data encryption may be used as a means to protect both active data, as well as inactive data stored in, for example, a data storage drive. Use of encryption technology to protect inactive data is referred to herein as “storage encryption,” and may include the use of encryption/decryption of backed-up and/or archived data, in transit and/or on storage media. Storage encryption may be desirable as a feature of storage security in storage area networks (SANs), for example.

Storage encryption may be implemented in one of the following encryption models: (1) file-based encryption, wherein encryption keys are associated with host I/O commands issued to the relevant storage device; (2) raw data encryption, wherein encryption keys are associated with sets of logical block addresses (LBAs) and offset LBAs within data base record(s); and self-encrypting device (SED) encryption, wherein encryption keys are associated with LBA ranges (or logical page ranges).

SEDs may be designed to support certain industry specifications, such as the Opal Security Subsystem Class Specification (e.g., PC solutions) or the Enterprise Security Subsystem Class Specification (e.g., data center solutions), produced by Trusted Computing Group (TCG). Furthermore, self-encrypting technology may be integrated in a data storage drive, or may be embodied in drive-management software available from third parties.

Use of SED encryption may provide various benefits. For example, SEDs may provide encryption transparency, such that system and/or application modifications are not necessary to implement the data encryption. In certain embodiments, encryption keys are generated during manufacturing by, e.g., on-drive random number processes. SEDs may be configured to encrypt all data stored thereon that meets certain criteria, thereby potentially reducing the risk of neglecting to encrypt sensitive data by the host system. Furthermore, SED systems generally do not require host key management, thereby increasing the ease of management. Re-purposing and/or re-encryption costs may also be relatively low with SEDs. If a self-encrypting drive is lost or stolen, data may be inaccessible except to the authorized user. Furthermore, in certain embodiments, drives can be very quickly and completely erased, making re-use or disposal efficient and safe.

Although SEDs can provide certain benefits, storage drives are often used in systems configured to implement other, non-SED, encryption. Certain embodiments disclosed herein provide data storage drives configured to support multiple encryption models, such as SED encryption, file-based encryption, raw data encryption, and/or other variations. In certain embodiments, such encryption flexibility is embodied in a controller chip in a data storage device, such as in a single solid-state drive (SSD) controller chip.

### Storage Encryption System

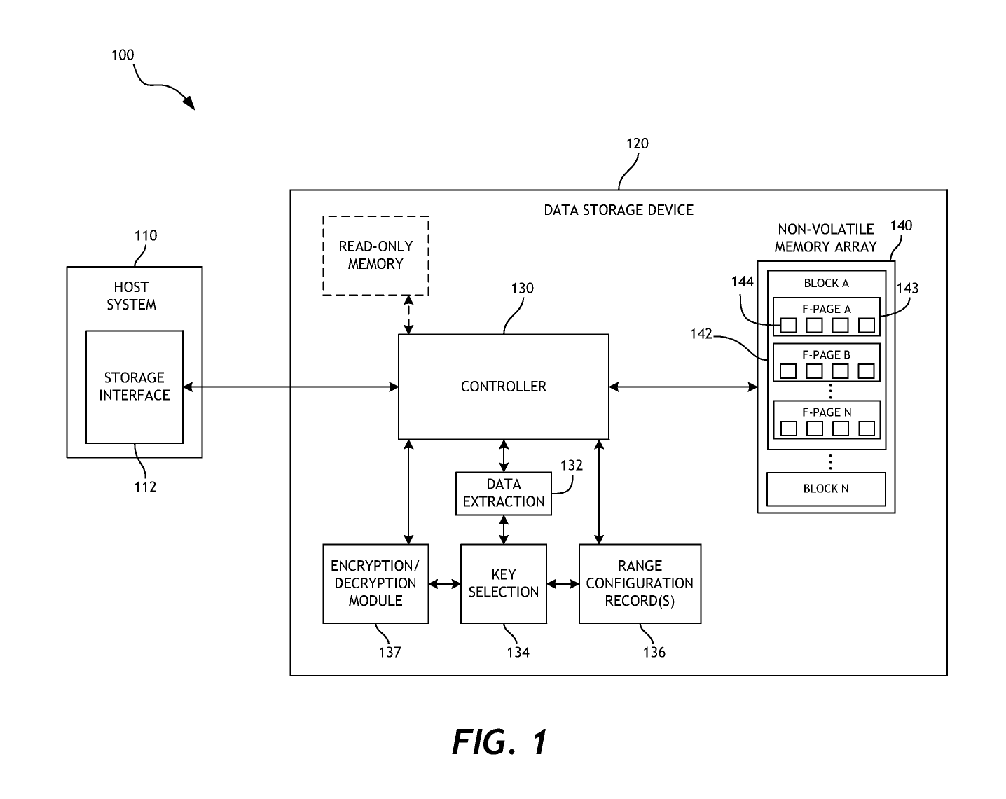

FIG. 1 is a block diagram illustrating a data storage device 120 (e.g., an SED) according to an example embodiment. Referring to FIG. 1, a data storage device 120 may include a controller 130 and a non-volatile memory array 140. In an embodiment, the non-volatile memory array comprises solid-state memory, such as NAND flash, and/or non-volatile magnetic media. The controller 130 may provide overall control for the data storage device 120. The non-volatile memory array 140 may include one or more blocks of solid-state storage 142. While a single non-volatile memory array 140 is illustrated for convenience, one of ordinary skill in the art will appreciate that the data storage device 120 may include a plurality of, for example, non-volatile solid-state memory arrays. In certain embodiments, the data storage device 120 may be, for example, a hybrid hard drive, or a hard disk drive.

A block 142 of the non-volatile memory array 140 may include a plurality of flash pages (F-pages) 143. In some example embodiments, each F-page is a smallest grouping of memory cells in the non-volatile memory array 140 that can be programmed in a single operation, or as a unit. Alternatively to, or in addition to, solid-state memory, magnetic rotating media and/or other non-volatile memory such as MRAM and/or phase change memory may be used.

The controller 130 may receive data and storage access commands from a storage interface 112 (e.g., a device driver) in a host system 110. Storage access commands communicated by the storage interface 112 may include write and read commands issued by the host system 110. The storage access commands may specify an LBA, or range of LBAs, in the data storage device 120, and the controller 130 may execute the received storage access commands in the non-volatile memory array 140. In a hybrid hard drive, data may be stored in a magnetic media storage component (not illustrated) in addition to non-volatile solid-state memory.

The data storage device 120 may store data received from the host system 110, such that the data storage device 120 can act as memory for the host system 110. To facilitate this memory function, the controller 130 may implement a logical interface. The logical interface may present to the host system 130 the memory of the data storage device 120 as a set of logical addresses (e.g., contiguous address) where data can be stored. The controller 130 may map logical addresses to various physical memory addresses in the non-volatile memory array 140 and/or other memory module(s).

The data storage device 120 may be configured to encrypt host data using media encryption keys and store the data in the non-volatile memory array 140. Key management, including generation, exchange, storage, usage, and/or replacement of keys, and/or key scheduling, may be performed at least in part by the controller 130 and/or other illustrated components of the data storage device 120. The data storage device 120 and/or controller 130 may be configured to maintain key configuration data 136 corresponding to ranges of LBAs of the non-volatile memory array 140.

In order to provide efficient key selection and/or loading, the data storage device 120 may implement a mechanism for automatically loading the key when an instruction is received from the host 110. For example, one or more parameters of the host command may be checked to determine what key is to be used. In certain embodiments, the data storage device 120 is configured to generate and/or maintain one or more media encryption keys associated with the LBA ranges, or other subsets or partitions of the non-volatile memory array 140. Therefore, LBA data from the host command may be relied upon to determine the appropriate key. However, as various potential host systems may utilize encryption models other than an LBA-based key selection model, it may be beneficial for the data storage device 120 to be configurable for one or more other key selection models, as described in further detail below.

The data storage device 120 may utilize different types of keys, and may use multiple keys. For example, the data storage device 120 may utilize symmetric keys and/or asymmetric keys. In certain embodiments, encryption keys are 128 or 256 bit Advanced Encryption Standard (AES) keys.

In certain embodiments, the data storage device 120 may include an encryption/decryption module 137. The encryption/decryption module 137 may be configured to perform encryption and/or decryption of data that is stored in at least a portion of the non-volatile memory array 140. In one example embodiment, the encryption/decryption module 137 is configured to encrypt/decrypt data according to one or more keys selected on a per-command basis.

In certain embodiments, the data storage device 120 may include a key selection module 134 that provides encryption keys to the encryption/decryption module 137 in response to data extracted from host I/O commands. In certain embodiments, the controller 130 may perform at least a portion of the functions of the encryption/decryption module 137 and/or the key selection module 134.

### Key Selection

Certain embodiments disclosed herein provide for support of different data storage security models, as described above, in a single controller chip or device. In certain embodiments, the use of hardware-based key selection circuitry, wherein encryption keys are selected substantially without firmware intervention, allows for encryption flexibility without substantial relative degradation in encryption performance.

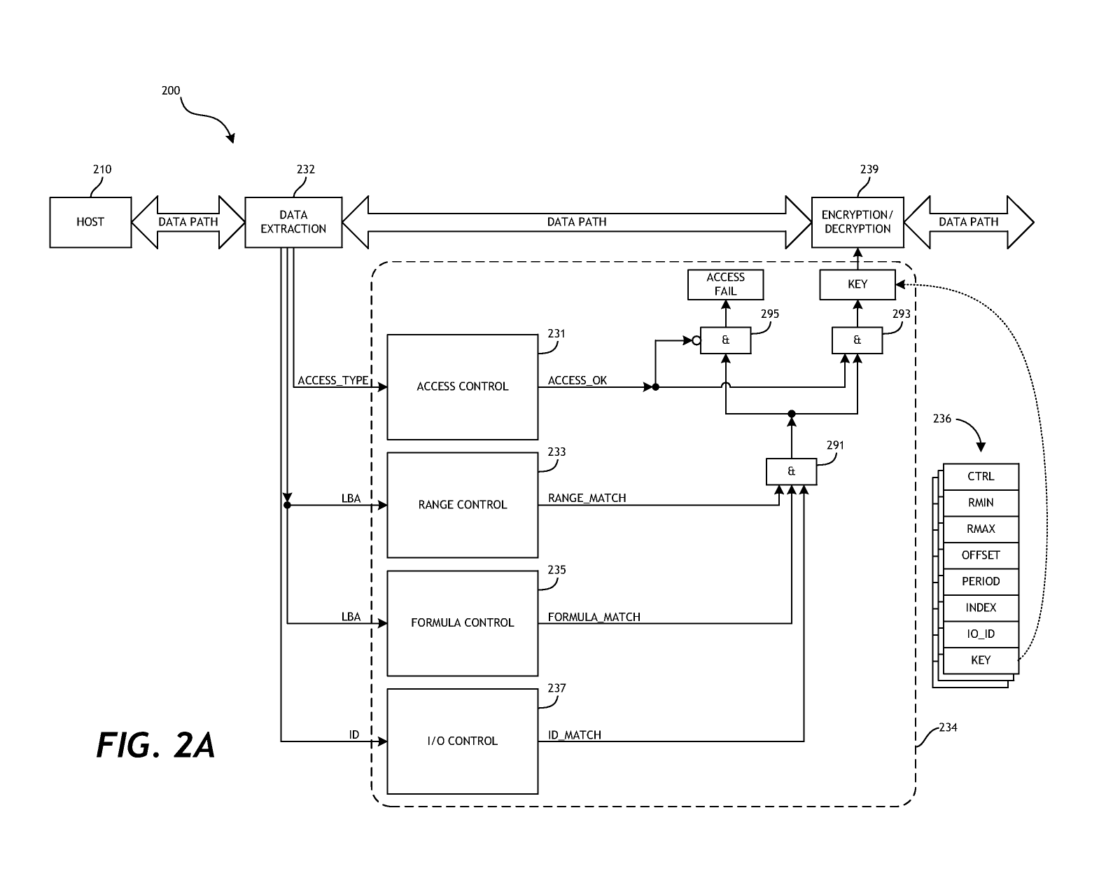

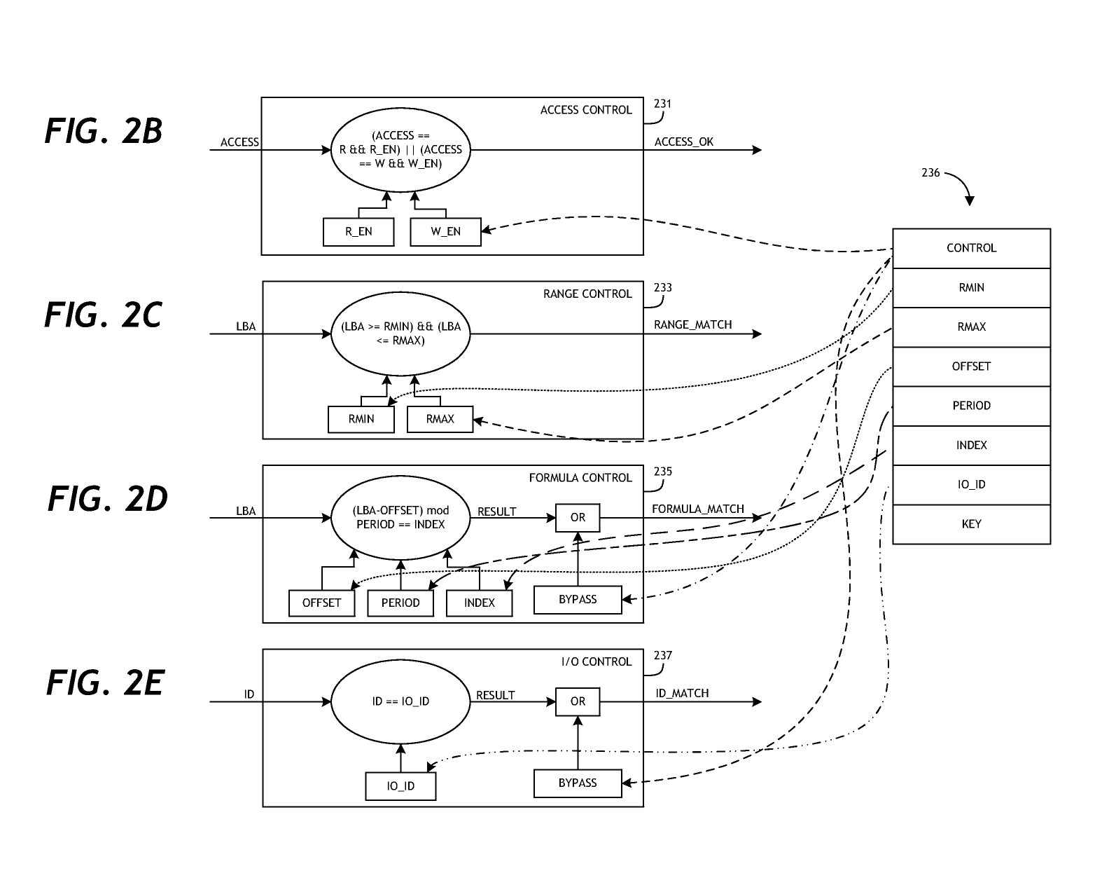

FIG. 2 illustrates a storage encryption system 200 including encryption key selection circuitry 234 configured to select encryption keys based at least in part on a host I/O command, wherein the key is used for encrypting and/or decrypting host data associated with the host I/O command. In an example embodiment, key data may be maintained by a SED device, wherein key data, along with other related data, is maintained in one or more key configuration records 236. For example, different keys and/or security configurations may be associated with different LBA ranges of the SED device.

In certain embodiments, the key selection circuitry 234 may be configured to provide key data for SED encryption, file-based encryption, raw data encryption, and/or other encryption model. In order to provide such encryption flexibility, the key selection circuitry may comprise a plurality of control modules, which may selectively control the selection and/or provision of encryption keys. In the system 200 of FIG. 2A, I/O commands are received from a host device 210 and provided to a data extraction module 232 configured to extract certain pieces of data from the host commands. The data encryption module 232 may be integrated into the command data path. In certain embodiments, host I/O commands may comprise one or more of the following parameters: access-type (ACCESS_TYPE) information, indicating, for example, whether the data access requested in the command is read access, write access, etc.; LBA information (LBA), indicating LBA(s) associated with the command; and I/O ID information, identifying, for example, a file or object associated with the command.

The system 200 includes an access control module 231, which may be configured to receive the access-type information (e.g., a value indicating whether the associated command is a read or write access command) from the data extraction module 232. The access control module may compare the access type with configured permissions. Access permissions may be configured on a user-by-user basis. If the access type is permitted for the particular command/user, then the access control module 231 may generate an access signal allowing key selection in the remaining blocks/circuitry to proceed. If access is not permitted based on the access type, the access control module 231 may generate a signal that causes an access fail exception, whereby the key selection circuitry 234 may not provide a key for encrypting/decrypting the associated data. The triggering of the access failure may be effected through the use of certain logic, such as an AND block 295 having as an input thereto the logical complement of the output signal from the access control module 231.

The key selection circuitry 234 further comprises a range control module 233, which may be configured to provide key selection functionality for SED encryption. In an SED encryption mode, the formula control module 235 and/or I/O control module 237 may be bypassed. For example, when bypassed, the outputs of the formula control module 235 and I/O control module 237 may be set to a positive value, such that the output of the AND block 291 is determined by the output of the range control module 233. The output of the range control module 233 may indicate whether the LBA(s) of the I/O command are within configured values. In certain embodiments, the range control module 231 may not be bypassed. However, in certain embodiments, the range control module 231 may be configured as a global range to cover all media, such that the output signal of the range control module 233 is effectively set to a positive value for all valid media access commands.

The formula control module 235 may be utilized in a raw data encryption mode of operation, wherein the selected key is associated with the LBA(s) of the command, offset by some value. The offset data, and other relevant data, may be contained in, and obtained from, the associated record configuration record 236. For example, where a data storage device may not maintain a file system, but instead merely maintains the raw data of the database, the host system may have knowledge of how many LBAs are used for each database record. For example, if the data storage device uses 5 LBAs for each database record, LBA numbers 0-4 may correspond to one record, while LBA numbers 5-9 correspond to another record, etc. If the host wishes to read database record number 3, for example, it may issue a read command for LBA numbers 10-14 to obtain the data. Therefore, the system 200 may maintain relationships between LBA number and database record. A formula may be used to determine the LBA/record association. In certain embodiments, database records may have different segments associated with different levels of access. Therefore, different keys may be maintained for the different database segments. In certain embodiments, the system 200 maintains only a single database record, wherein all other modules of the key selection circuitry are bypassed.

The I/O control module 237 may be utilized in a file-based encryption mode of operation, wherein an encryption key is associated with an identification value (ID) of the I/O command. In the file-based encryption mode, the formula control module 235 may be bypassed, and vice-versa with respect to the raw-data encryption mode. A host system may utilize file-based encryption by embedding the ID associated with a selected one of the cached keys stored in the data storage device.

In the system 200, the outputs of the access control module 231, range control module 233, formula control module 235, and I/O control module 237 are analyzed by hardware logic to determine whether a key associated with the relevant I/O command is to be loaded into the encryption/decryption engine/module 239. In certain embodiments, access failure signals are handled by system firmware. As shown in FIG. 2A, a single SED/controller may be configurable to accommodate different encryption models. This may provide manufacturing benefits, as a single controller hardware design may be reusable in servicing different types of host systems.

FIGS. 2B-2E provide further details of operation for the access control module 231, range control module 233, formula control module 235 and I/O control module 237, respectively, as shown in FIG. 2A. The key configuration record 236 of FIG. 2A may include various data parameters associated with one or more encryption keys. Proper configuration of permissions and other parameter values may be the responsibility of firmware in certain embodiments. The key configuration records 236 may be maintained as a system table in the data storage device.

As described above, an encryption key may be associated with a range of LBAs in a SED encryption mode of operation. The key configuration record 236 may therefore include data identifying a range of LBAs associated with a key. For example, the record may include values identifying beginning (RMIN) and/or end (RMAX) points of an LBA range. The logical function ((LBA >=RMIN) && (LBA<=RMAX)) illustrated in FIG. 2C is an example of how such data may be used to generate a range control output signal according to one embodiment. However, other algorithms/logic may be implemented in certain embodiments. For the sake of simplicity, the FIG. 2C does not show the mechanism of range crossing detection. Furthermore, the logic of selection between global and local ranges is not shown, though it should be understood that the range control module 233 may include such logic.

For file-based encryption, a key may be associated with, for example, an I/O ID value (IO_ID). The logical function (ID==IO_ID) illustrated in FIG. 2E is an example of how such data may be used to generate an I/O control output signal according to one embodiment. However, other algorithms/logic may be implemented in certain embodiments.

For raw data encryption, a key may be based on various other data values, such as an LBA offset value (OFFSET), an index value (INDEX), a period value (PERIOD). The logical function ((LBA-OFFSET) mod PERIOD==INDEX) illustrated in FIG. 2D is an example of how such data may be used to generate a formula control output signal according to one embodiment. However, other algorithms/logic may be implemented in certain embodiments.

For the access control module 231, whether certain types of access are permitted may be based on control data contained within the configuration record 236 associated with the particular I/O command. For example, different access rights may be granted for read and write requests, as demonstrated by the logical function ((ACCESS==R && R_EN) 11 (ACCESS==W && W_EN)) illustrated in FIG. 2A, which is an example of how write-enable and/or read-enable data may be used to generate the access control output signal in certain embodiments, wherein ‘R’==1 indicates that the I/O command is a read command, ‘W’==1 indicates that the I/O command is a write command, ‘R_EN’ indicates whether read access is allowed and ‘W_EN’ indicates whether write access is allowed.

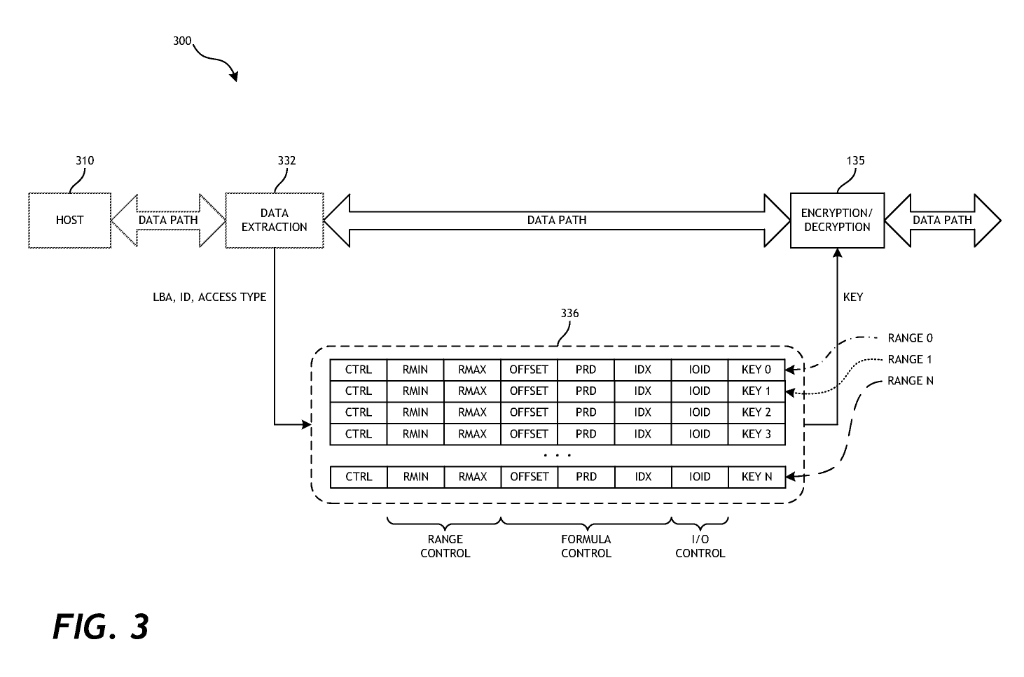

FIG. 3 illustrates a storage encryption system 300 including a set of key configuration records 336. As shown in FIG. 3, and referenced above, a storage device may maintain a plurality of key configuration records, each associated with a different LBA range. For example, the set 336 may comprise 1024 records in order to support TCG Enterprise standards. In certain embodiments, the set of configuration records 336 is designed such that each I/O command provided by the host 310 is associated with not more than one selected encryption key. Range configuration for encryption keys may be at least partially controlled by firmware according to internal device configuration and/or host commands.

Table A below provides examples of the possible module configurations according to the system 200 of FIG. 2A:

TABLE A

| SECURITY | RANGE | FORMULA | I/O | EXAMPLE |
|---|---|---|---|---|
| MODEL | MODULE | MODULE | MODULE | IMPLEMENTATION |
| Class 0 | One global | Bypass | Bypass | Controlled by ATA |
| | range | | | security commands |
| SED | Multiple | Bypass | Bypass | Controlled by TCG |
| Encryption | ranges | | | protocol, key is |
| | | | | associated with LBA |
| | | | | range |
| Raw Data | One or | Configured | Bypass | Number of ranges |
| Encryption | multiple | | | depends on number of |
| | | | | databases stored on |
| | | | | the device. Total |
| | | | | number of used |
| | | | | records depends on |
| | | | | the length of database |
| | | | | record. Controlled by |
| | | | | VSC or new TCG SSC |
| | | | | (proposed). |
| File-Based | From one to | Bypass | Configured | May use different set of |
| Encryption | number of | | | cached keys for each |
| | partitions | | | partition or one set for |
| | | | | the whole drive. |
| | | | | Controlled by VSC or |
| | | | | new TCG SSC |
| | | | | (proposed). |
| Mixed | As minimum | Configured | Configured | Server may use file- |
| Compatibility | two | | | based or SED |
| | | | | encryption for the |
| | | | | bootable and users |
| | | | | partitions, and raw data |
| | | | | partitioning to store |
| | | | | secure database |

Table B below illustrates an example configuration of a data storage device configured according to one or more embodiments disclosed herein. The example device embodied in Table B may be configured for mixed-compatibility for multiple security models, as described above.

TABLE B

| REF | R | W | FBPS | IBPS | RMIN | RMAX | OFFSET | PERIOD | INDEX | ID | KEY |
|---|---|---|---|---|---|---|---|---|---|---|---|
| 1 | 1 | 0 | 1 | 1 | 0 | 999 | | | | | 1 |
| 2a | 1 | 1 | 1 | 0 | 1000 | 9999 | | | | 0 | 2 |
| 2b | 1 | 1 | 1 | 0 | 1000 | 9999 | | | | 1 | 3 |
| 2c | 1 | 1 | 1 | 0 | 1000 | 9999 | | | | 2 | 4 |
| 3 | | | 1 | 1 | 10000 | 19999 | | | | | 5 |
| 4a | 1 | 1 | 1 | 1 | 20000 | 20999 | | | | | 6 |
| 4b.1 | | | | 1 | 21000 | 49999 | 21000 | 3 | 0 | | 7 |
| 4b.2 | | | | 1 | 21000 | 49999 | 21000 | 3 | 1 | | 8 |
| 4b.3 | | | | 1 | 21000 | 49999 | 21000 | 3 | 2 | | 9 |
| 4c.1 | | | | 1 | 50000 | 99999 | 50000 | 5 | 0 | | 10 |
| 4c.2 | | | | 1 | 50000 | 99999 | 50000 | 5 | 1 | | 10 |
| 4c.3 | | | | 1 | 50000 | 99999 | 50000 | 5 | 2 | | 10 |
| 4c.4 | | | | 1 | 50000 | 99999 | 50000 | 5 | 3 | | 10 |
| 4c.5 | | | | 1 | 50000 | 99999 | 50000 | 5 | 4 | | 11 |

The example configuration of Table B includes a boot partition in LBA range 1-999, wherein the partition is configured as read-only. The system partition (LBAs 1000-9999) is configured in file-based encryption for three users. The third partition may correspond to a SED partition (LBAs 10000-19999). LBA range 20000-99999 may correspond to a raw database partition in 20000-99999, including an unencrypted index partition (LBAs 20000-20999), a first database with records aligned to a 3-LBA period (21000-49999), and a second database with records aligned to 5-LBA period (50000-99999), wherein the data is separated into two access groups (0-3 and 4), wherein number 4 is restricted with a separate key.

Since the competing storage security models described herein may entail different key-selection mechanisms, certain embodiments described herein may provide device automation, allowing for compliance with market requirements without the need to change device hardware. Because logic may be reused for different security models, manufacturing costs may be reduced for manufacturing devices compliant across models.

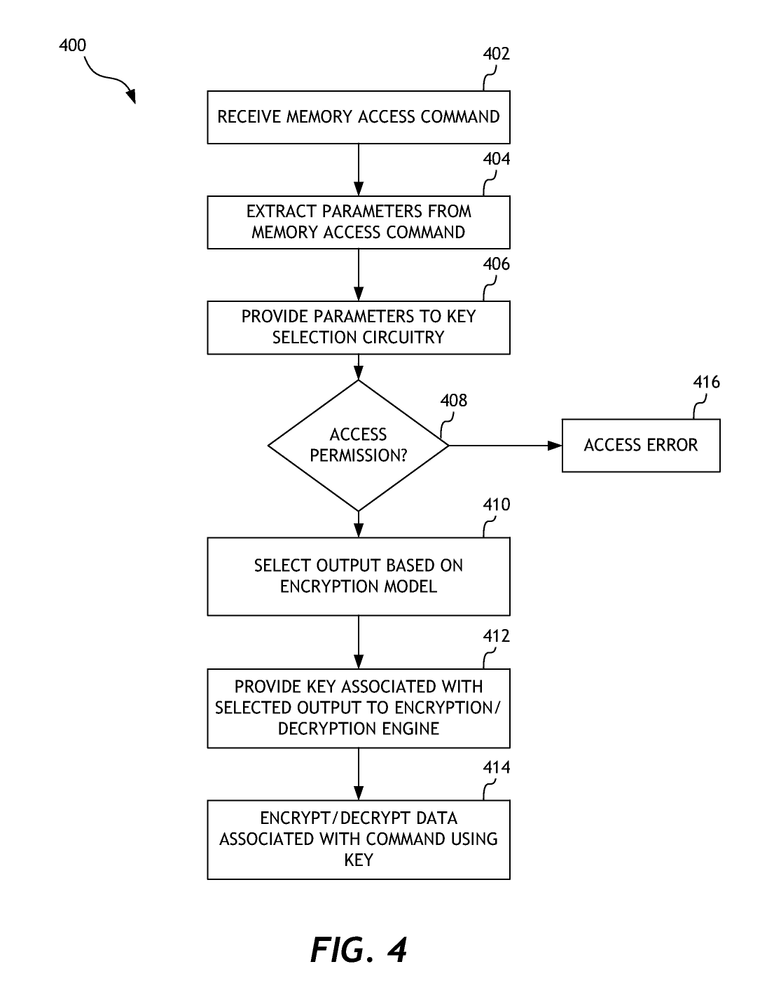

FIG. 4 is a flow diagram illustrating a process 400 for selecting encryption keys according to an embodiment. In an embodiment, the process 400 is performed at least partially by the controller 130, data extraction module 132, encryption/decryption module 137, and/or key selection module 134 as described above in connection with FIG. 1. The process 400 involves receiving a memory access command from a host system. For example, the memory access command may be a read or write command, or the like. At block 404, one or more parameters are extracted from the memory access command, such as LBA data, key ID data, or other parameter data as described in greater detail above. The extracted parameter data is provided to key selection circuitry for operation thereon at block 406.

In certain embodiments, the parameter data includes data indicating associated with user/host access permissions. At decision block 408, it is determined whether the access permissions of the user/host are sufficient for executing the memory access command. If not, the process 400 terminates at block 416 where an access error exception is thrown. If access is allowed, the process 400 continues to block 410, where an output of the key selection circuitry is selected based on a configured encryption model. The selection may be performed by system firmware.

At block 412, an encryption key associated with the selected output is provided to an encryption/decryption engine. At block 414, the encryption/decryption engine uses the key to encrypt or decrypt data associated with the memory access command.

### Additional Embodiments

Those skilled in the art will appreciate that in some embodiments, other types of storage encryption systems can be implemented while remaining within the scope of the present disclosure. In addition, the actual steps taken in the processes discussed herein may differ from those described or shown in the figures. Depending on the embodiment, certain of the steps described above may be removed, others may be added.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. The accompanying claims and their equivalents are intended to cover such forms or modifications as would fall within the scope and spirit of the protection. For example, the various components illustrated in the figures may be implemented as software and/or firmware on a processor, ASIC/FPGA, or dedicated hardware. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A data storage device, comprising:
a non-volatile memory;
an engine for performing at least one of encryption and decryption; and
a controller configured to:
receive a memory access command from a host system;
extract one or more parameters from the memory access command;
provide the one or more parameters to key selection circuitry, the key selection circuitry comprising:
a first key selection module configured to receive a first input parameter of the one or more parameters and generate a first output signal associated with a first encryption scheme; and
a second key selection module configured to receive a second input parameter of the one or more parameters and generate a second output signal associated with a second encryption scheme different from the first encryption scheme;
select one of the first output signal and the second output signal;
provide a key associated with the selected output signal to the engine; and
cause the engine to encrypt or decrypt data associated with the memory access command using the key.

2. The data storage device of claim 1, wherein the controller is further configured to maintain one or more configuration records, wherein each of the configuration records includes a single encryption key.

3. The data storage device of claim 2, further comprising device firmware, wherein the controller is further configured to generate the one or more configuration records based at least in part on the device firmware.

4. The data storage device of claim 1, wherein the one or more parameters includes:
logical block address (LBA) data or logical page data; and
memory access permission data.

5. The data storage device of claim 4, wherein the one or more parameters further includes a key index value.

6. The data storage device of claim 1, wherein the first key selection module corresponds to a logical block address (LBA) range-based encryption scheme and the second key selection module corresponds to a file-based encryption scheme.

7. The data storage device of claim 6, wherein the first input parameter comprises LBA data associated with the memory access command and the second input parameter comprises a key index value.

8. The data storage device of claim 7, wherein when the first output signal is the selected output signal, the controller is further configured to provide the key from a configuration record comprising the key and data defining a range of LBAs, wherein the LBA data associated with the memory access command identifies one or more LBAs within the range of LBAs.

9. The data storage device of claim 7, wherein when the second output signal is the selected output signal, the controller is further configured to provide the key from a configuration record comprising the key and the key index value.

10. The data storage device of claim 7, wherein the key selection circuitry further comprises a third key selection module configured to receive the first input parameter and generate a third output signal associated with a third encryption scheme.

11. The data storage device of claim 10, wherein the third encryption scheme is a raw data encryption scheme.

12. The data storage device of claim 1, wherein the key selection circuitry comprises hardware logic modules.

13. The data storage device of claim 1, wherein the key selection circuitry further comprises a key access module configured to receive one or more access permission parameters of the one or more parameters and generate an access signal indicating whether the host system has permission to access a portion of the non-volatile memory associated with the memory access command.

14. The data storage device of claim 13, wherein the one or more access parameters indicate an access type, wherein the access type is one of read access or write access.

15. The data storage device of claim 1, wherein the first output signal is the selected output signal when the second key selection module is bypassed.

16. A controller, comprising:
a processor; and
key selection circuitry;
wherein the processor is configured to:
receive a memory access command;
extract one or more parameters from the memory access command;
provide the one or more parameters to the key selection circuitry, the key selection circuitry comprising:
a first key selection module configured to receive a first input parameter of the one or more parameters and
generate a first output signal associated with a first encryption scheme; and
a second key selection module configured to receive a second input parameter of the one or more parameters and generate a second output signal associated with a second encryption scheme different from the first encryption scheme;
select one of the first output signal and the second output signal; and
use a key associated with the selected output signal to encrypt or decrypt data associated with the memory access command.

17. The controller of claim 16, wherein the one or more parameters includes:
logical block address (LBA) data or logical page data; and
memory access permission data.

18. A method of selecting an encryption key in a data storage system, the method comprising:
receiving a memory access command from a host system;
extracting one or more parameters from the memory access command;
providing the one or more parameters to key selection circuitry, the key selection circuitry comprising:
a first key selection module configured to receive a first input parameter of the one or more parameters and generate a first output signal associated with a first encryption scheme; and
a second key selection module configured to receive a second input parameter of the one or more parameters and generate a second output signal associated with a second encryption scheme different from the first encryption scheme;
selecting one of the first output signal and the second output signal;
providing a key associated with the selected output signal to an engine for performing at least one of encryption or decryption; and
causing the engine to encrypt or decrypt data associated with the memory access command using the key;
wherein the method is performed under the control of a controller of the data storage system.

19. The method of claim 18, wherein the first key selection module corresponds to a logical block address (LBA) range-based encryption scheme and the second key selection module corresponds to a file-based encryption scheme.

20. The method of claim 18, wherein the key selection circuitry further comprises a third key selection module configured to receive the first input parameter and generate a third output signal associated with a third encryption scheme.
